(19) United States
(12) Patent Application Publication
(10) Pub. No.: US 2026/0300919 A1
(43) Pub. Date: Oct. 1, 2026

(54) AI-Powered Real-Time Collaboration Enhancement Tool

(71) Applicant: Alexander Edward Juhasz, Midland, MI (US)

(72) Inventor: Alexander Edward Juhasz, Midland, MI (US)

(21) Appl. No.: 19/091,722

(22) Filed: Mar. 26, 2025

(51) Int. Cl. G06Q 10/101; G06F 16/242

(52) U.S. Cl. CPC G06Q 10/101; G06F 16/2425; G06F 16/2428; G06F 16/243

(57) ABSTRACT

An AI-driven collaboration system enhances live and asynchronous collaboration by analyzing collaboration data from a collaboration session to determine that an unresolved topic requires expert input without requiring a participant-entered expert query. The system generates a session-linked expert-engagement state and an AI-driven expert request including context information, identifies candidate experts using an expert profile database, and presents an expert-engagement control in a graphical user interface for participant confirmation. In response to confirmation, the system transmits a context-aware invitation including a selectable link or control for joining the collaboration session or contributing through a collaboration interface associated with the session. The system receives expert input, updates expert-engagement status, and may generate follow-up queries or supplemental summaries when unresolved discussion points remain.

### REFERENCE TO RELATED APPLICATIONS

This application claims the benefit of U.S. Provisional Application No. 63/571,479, filed Mar. 29, 2024, the entirety of which is incorporated herein by reference.

### BACKGROUND OF THE INVENTION

Modern collaboration environments rely heavily on virtual meetings, real-time messaging, and digital communication tools to facilitate decision-making. However, remote work lacks the organic engagement found in physical office settings, where individuals overhear discussions and naturally join conversations when relevant. In traditional offices, casual exposure to ongoing discussions encourages impromptu contributions from the right people at the right time, fostering collaboration and improving decision-making. In domains such as healthcare, legal proceedings, and engineering, the absence of timely expert input can lead to costly mistakes, operational inefficiencies, and suboptimal decision-making. Existing remote collaboration tools often fail to replicate this dynamic. While some solutions offer structured polling or post-meeting summaries, they do not actively bring in the right participants in real time. Instead, teams often rely on manual follow-ups, email exchanges, or ad-hoc outreach, leading to inefficiencies, missed insights, and decision delays. This invention addresses these challenges by introducing an AI-driven enhancement system that dynamically identifies expertise gaps within conversations, recommends subject matter experts, and facilitates seamless integration of these experts into discussions. Unlike conventional methods that depend on predefined tags, static skill databases, or manual post-meeting reviews, this system continuously analyzes active conversations using machine learning and natural language processing (NLP) to detect topics or conversations that would benefit from engagement with specific individuals or experts. It then queries a dynamically updated user profile database to match discussions with the most relevant experts, considering availability, historical engagement, and contextual relevance. Once an expert is identified, the system employs an intelligent decision logic framework to determine the optimal method of engagement-whether through automatic invitations or suggested participation. Experts who are unavailable during live discussions can receive context-aware notifications with summarized conversation details, allowing them to provide retrospective input without disrupting workflow. By integrating across multiple communication platforms, the system ensures that expertise is accessible regardless of time constraints, enabling both synchronous and asynchronous collaboration. Through continuous learning, the system refines its recommendations based on historical interaction patterns, user feedback, and contextual analysis, ensuring that expert involvement remains relevant and accurate over time. This approach not only reduces delays but also enhances efficiency, fosters better knowledge distribution, and supports

### DESCRIPTION

The techniques disclosed herein provide an AI-driven expert engagement system for use with real-time or asynchronous collaboration environments. The system may analyze collaboration data, identify topics or discussion points that may require expert input, and initiate an expert-engagement workflow. The system may apply artificial intelligence, machine learning, natural language processing, and contextual analysis to determine when subject matter expertise may be useful within a collaboration session.

Dynamic Expert Identification: The system may analyze discussion topics, shared documents, participant engagement levels, transcript content, user-interface interactions, and other collaboration data to determine whether an expertise gap exists. Through speech-to-text conversion, natural language processing, and one or more contextual signals, optionally including sentiment indicators, the system may identify whether an ongoing collaboration session would benefit from additional expertise. Instead of relying solely on manual outreach, the system may search authorized internal or external expert-profile data sources to identify relevant experts. The system may refine recommendations based on previous interactions, expertise availability, relevance to the detected topic, and feedback associated with prior expert engagements.

Automated Expert Invitations: Once an expertise requirement is identified, the system may generate invitations or notifications for one or more candidate experts. These invitations may be delivered through email, chat platforms, meeting-management tools, or other communication channels. The invitations may include a contextual summary of the discussion, a reference to relevant collaboration content, and a selectable control for joining a live session or contributing asynchronously. If an expert is unavailable during the live session, the expert may contribute asynchronously by providing recorded responses, text-based feedback, annotations, or document-review comments. The system may also cross-reference expert availability with meeting timing and may identify alternative experts when a primary candidate is unavailable. The system may rank candidate experts based on expertise relevance, prior contributions, availability, responsiveness, organizational relationship, or authorized expert group membership.

### BRIEF STATEMENT OF THE INVENTION

The present disclosure provides an AI-driven collaboration enhancement system that dynamically identifies unresolved topics requiring expert input and integrates expert input into live or asynchronous collaboration workflows. By analyzing collaboration data, the system may determine when additional expertise is needed without requiring a participant-entered expert query, present an expert-engagement control within a collaboration-platform graphical user interface, transmit a context-aware invitation to a selected expert, and display expert-engagement status and expert input within the collaboration platform.

### RELATED TECHNOLOGY

The present disclosure relates to collaboration systems, expert-identification systems, recommendation systems, notification systems, and communication-platform interfaces. Some existing systems may identify experts or other users based on profile data, user queries, stored expertise information, prior responses, or other knowledge-management information. Other systems may provide meeting summaries, structured polling, messaging features, or post-meeting follow-up tools.

The present disclosure describes additional implementations in which collaboration data from a live or asynchronous collaboration session may be analyzed to identify an unresolved topic or other discussion point for which expert input may be useful. In some implementations, the system may generate a context-aware expert request, present an expert-engagement control within a collaboration-platform graphical user interface, transmit a context-aware invitation to a selected expert, receive live or asynchronous expert input, update expert-engagement status, and associate expert input with the collaboration session.

### BRIEF DESCRIPTION OF THE DRAWINGS

The detailed description is described with reference to the accompanying FIG. In the figures, the left-most digit or digits of a reference number identify the figure in which the reference number first appears. The same reference numbers in different figures indicate similar or identical items.

FIG. 1 is a diagram illustrating an example system environment in which an AI-driven expert engagement system is communicatively coupled to participant devices, expert devices, a collaboration platform, and an expert profile database through one or more networks.

FIG. 2 is a diagram illustrating example computing-device components configured to perform collaboration-data collection, artificial-intelligence analysis, expert recommendation, notification generation, graphical user interface generation, and expert input integration.

FIG. 3 is a diagram illustrating an example passive expertise-gap detection and expert matching workflow based on collaboration data, including text data, audio-derived transcript data, shared-document data, and user-interface interaction data.

FIG. 4 is a diagram illustrating an example follow-up query workflow in which expert input is analyzed to determine whether one or more unresolved discussion points remain and whether additional expert engagement is required.

FIG. 5 is an example graphical user interface showing expert engagement within a live collaboration session, including expert-engagement status and expert input associated with the collaboration session.

FIG. 6 is an example graphical user interface showing an expert-engagement control, a context-aware invitation panel, candidate expert information, and selectable live or asynchronous participation options.

FIG. 7 is an example expert device interface showing a session-linked collaboration view, a context-aware expert invitation, expert-engagement status, and controls for live participation, asynchronous contribution, or declining the invitation.

FIG. 8 is a flowchart illustrating an example method for detecting an unresolved topic requiring expert input, generating a session-linked expert-engagement state, generating a context-aware expert request, identifying one or more experts, transmitting a context-aware invitation, receiving expert acceptance or expert contribution, and displaying expert status and expert input.

FIG. 9 is a flowchart illustrating an example asynchronous expert engagement workflow, including authorized expert identification, asynchronous expert contribution, follow-up query generation, supplemental summary generation, and expert-engagement status updating.

### DETAILED DESCRIPTION

The present disclosure provides an AI-driven expert engagement system designed to enhance decision-making by integrating subject matter expertise into real-time and asynchronous collaboration environments. The system applies natural language processing, machine learning, and contextual analysis techniques to dynamically assess discussions, identify unresolved topics requiring expert input, and invite relevant experts at a relevant point in the collaboration workflow. In some implementations, system 102 maintains a session-linked expert-engagement state associated with the collaboration session. The session-linked expert-engagement state may identify an unresolved topic, context information derived from collaboration data, one or more candidate experts, participant confirmation status, invitation status, expert acceptance status, expert contribution status, follow-up status, and expert input associated with the collaboration session. The session-linked expert-engagement state may be updated as an expert request is generated, confirmed, transmitted, accepted, declined, completed, or followed up.

### System Overview

The expert engagement system may include a context analysis engine, an expert recommendation module, an automated notification system, a response integration framework, and a learning or adaptation mechanism. These components may operate together to identify topics that may require expert input, identify candidate experts, transmit invitations, receive expert responses, update expert-engagement status, and associate expert input with a collaboration session.
1. Context Analysis Engine: This module may monitor or receive collaboration data, including spoken communication, written communication, transcript content, shared-document content, and user-interface interaction data. The context analysis engine may use machine learning models, natural language processing, or other analysis techniques to identify topics, questions, repeated comments, missing expertise signals, or unresolved discussion points. The context analysis engine may also evaluate contextual signals, optionally including sentiment indicators, urgency indicators, references to prior expert discussions, or shared-content references.
2. Expert Recommendation Module: After an expertise need is identified, the system may query internal or external knowledge repositories, profile databases, or expert-profile data sources to identify one or more candidate experts. Candidate experts may be ranked based on subject matter expertise, prior contributions, availability, responsiveness, relevance, organizational relationship, project-team relationship, professional-network relationship, or authorized expert group membership. Expert selection criteria may be configurable by users or administrators.
3. Automated Notification System: Identified experts may receive targeted invitations or notifications through email, chat applications, meeting platforms, mobile alerts, or other communication channels. The notification may include context information, a session summary, a selectable join control, a selectable asynchronous contribution control, or a decline control. In some implementations, the notification system may identify an alternative expert if a selected expert is unavailable or declines the invitation.
4. Response Integration Framework: Experts may provide input synchronously by joining a live collaboration session or asynchronously through recorded messages, text-based annotations, document reviews, structured responses, or other collaboration interfaces. The system may integrate expert responses into meeting notes, transcripts, decision logs, session records, or graphical user interface displays. Natural language generation techniques may be used to generate structured summaries of expert responses.
5. Learning and Adaptation Mechanism: The system may update expert recommendations based on prior engagement results, user feedback, availability, response timeliness, expert contribution history, and changing organizational needs. In some implementations, a learning module may update expert ranking, matching, invitation timing, or follow-up logic over time.

### Key Functional Features

Predictive Expertise Identification: The system may identify potential expertise needs before a participant manually requests expert input by analyzing discussion history, repeated questions, unresolved comments, shared content, or recurring knowledge gaps.

Real-Time Speech and Text Processing: The system may transcribe and analyze spoken language, text messages, chat content, meeting metadata, shared-document interactions, and user-interface interaction data to identify topics or unresolved discussion points.

Adaptive Expertise Ranking: Candidate experts may be ranked based on relevance, prior engagement, current availability, responsiveness, profile data, project relationship, professional network relationship, or authorized expert group membership.

Multi-Platform Integration: The system may connect with collaboration platforms, messaging platforms, meeting platforms, scheduling tools, document-management systems, or enterprise systems through application programming interfaces or other integration mechanisms.

Secure and Compliant Knowledge Sharing: Access controls, configurable permissions, audit trails, encryption, or compliance settings may be used to control access to expert invitations, expert input, session records, or related collaboration data.

### System Architecture

The AI-driven expert engagement system may include several interconnected modules configured to support real-time or asynchronous expert engagement.
1. Data Collection Module: This module may collect or receive live conversation data, text data, transcript data, shared-document data, user-interface interaction data, and other collaboration data from a collaboration session.
2. Context Analysis Engine: This module may use natural language processing, machine learning, semantic analysis, or other techniques to determine whether expert input may be useful for a topic or unresolved discussion point.
3. Expert Recommendation Engine: This module may query an internal or external expert profile database to identify and rank candidate experts based on expertise, relationship, availability, relevance, contribution history, or responsiveness.
4. Automated Notification System: This module may transmit context-aware invitations through chat platforms, email, direct meeting invitations, mobile alerts, or other notification channels. The notification system may also support escalation or alternative-expert selection.
5. Response Integration Module: This module may receive expert input and associate the expert input with a meeting discussion, transcript, document, decision log, session record, or graphical user interface display.
6. AI Learning and Optimization System: This module may update expert recommendations or engagement logic based on prior engagement results, user feedback, expert responsiveness, or other collaboration data.

### Real-World Applications

This system may be used in healthcare, legal, engineering, finance, research, development, compliance, project-management, or other collaborative environments in which expert input may be useful during live or asynchronous workflows.

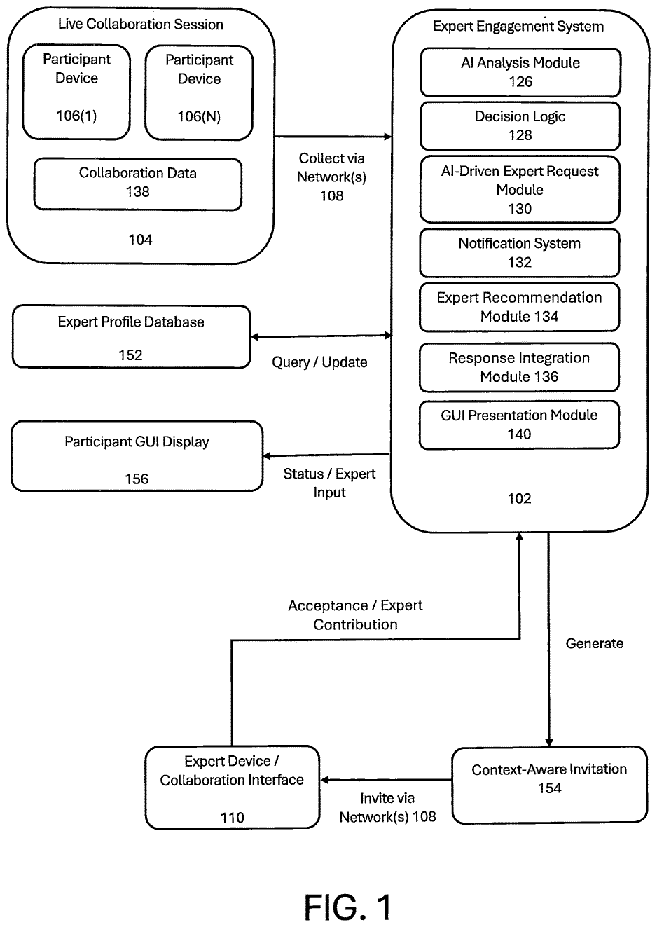

Various examples, implementations, scenarios, and aspects are described below with reference to FIGS. 1 through 9.

The disclosed system may be implemented in various configurations, including software-based implementations integrated into collaboration platforms, hardware-accelerated processing using CPUs, GPUs, FPGAs, or DSPs, and cloud-based or on-premise enterprise deployments. The system may monitor collaboration sessions, detect topics or unresolved discussion points that may require expert input, generate notifications or requests for expert engagement, present expert recommendations, track responses, and display expert status or expert input through a graphical user interface. The system may support parallel or asynchronous processing, adaptive workflows, reassignment or escalation of expert requests, and context-aware presentation of expert input associated with ongoing collaboration sessions.

### DETAILED DESCRIPTION OF THE FIGURES

The following are detailed descriptions of the figures.

FIG. 1 illustrates an example environment 100 in which a system 102 supports AI-driven expert engagement for a live collaboration session 104. The environment 100 may include participant devices 106(1)-106(N), one or more expert devices or collaboration interfaces 110, system 102, and an expert profile database 152 communicating over one or more networks 108. System 102 may include an AI analysis module 126, decision logic 128, an AI-driven expert request module 130, a notification system 132, an expert recommendation module 134, a response integration module 136, and a graphical user interface presentation module 140. System 102 may include or access the expert profile database 152. During operation, collaboration data 138 from the live collaboration session 104 may include text messages, audio-derived transcript content, shared-document content; video or meeting metadata, and user-interface interaction data. The AI analysis module 126 evaluates the collaboration data 138 to determine whether the live collaboration session 104 includes an unresolved topic that may require expert input. This determination may occur without requiring a participant-entered expert query. When an unresolved topic is identified, system 102 generates an AI-driven expert request including context information derived from the collaboration data 138. System 102 then identifies one or more candidate experts using the expert profile database 152 and may present the candidate experts to participants through a participant graphical user interface display 156. In response to participant confirmation, system 102 may transmit, via the one or more networks 108, a context-aware invitation 154 to a selected expert device or collaboration interface 110, receive an acceptance or expert contribution from the selected expert device or collaboration interface 110, and display an expert-engagement status or expert input through the participant graphical user interface display 156.

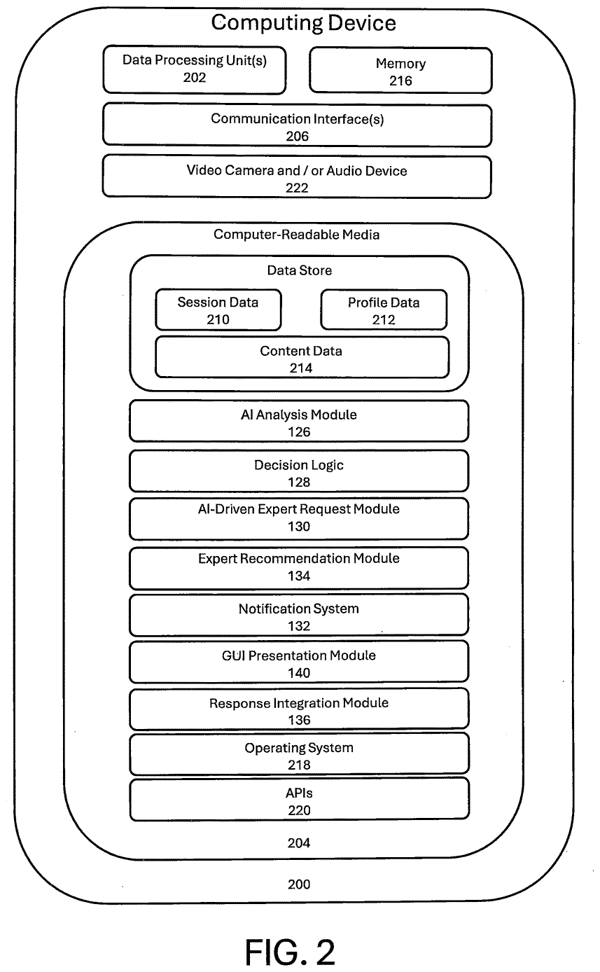

FIG. 2 illustrates example components of a computing device 200 that may implement one or more functions of system 102, a participant device 106, or an expert device or collaboration interface 110. The computing device 200 may include one or more data processing units 202, computer-readable media 204, communication interface(s) 206, memory 216, an operating system 218, one or more application programming interfaces 220, and, in some implementations, a video camera or audio device 222. The computer-readable media 204 may store session data 210, profile data 212, content data 214, and computer-executable instructions corresponding to an AI analysis module 126, decision logic 128, an AI-driven expert request module 130, a notification system 132, an expert recommendation module 134, a response integration module 136, and a graphical user interface presentation module 140. The AI analysis module 126 may process collaboration data to recognize unresolved topics, repeated or similar questions, missing expertise signals, shared-document interactions, or user-interface interaction data. The decision logic 128 or expert recommendation module 134 may access profile data 212 or query an expert profile database 152 to identify or rank candidate experts based on subject-matter expertise, prior contributions, availability, relevance, organizational relationship, or authorized expert group membership. The notification system 132 and graphical user interface presentation module 140 may generate context-aware invitations, display expert-engagement controls, present candidate experts for participant confirmation, and display expert-engagement status, including requested, reviewing, joined, declined, awaiting response, or completed.

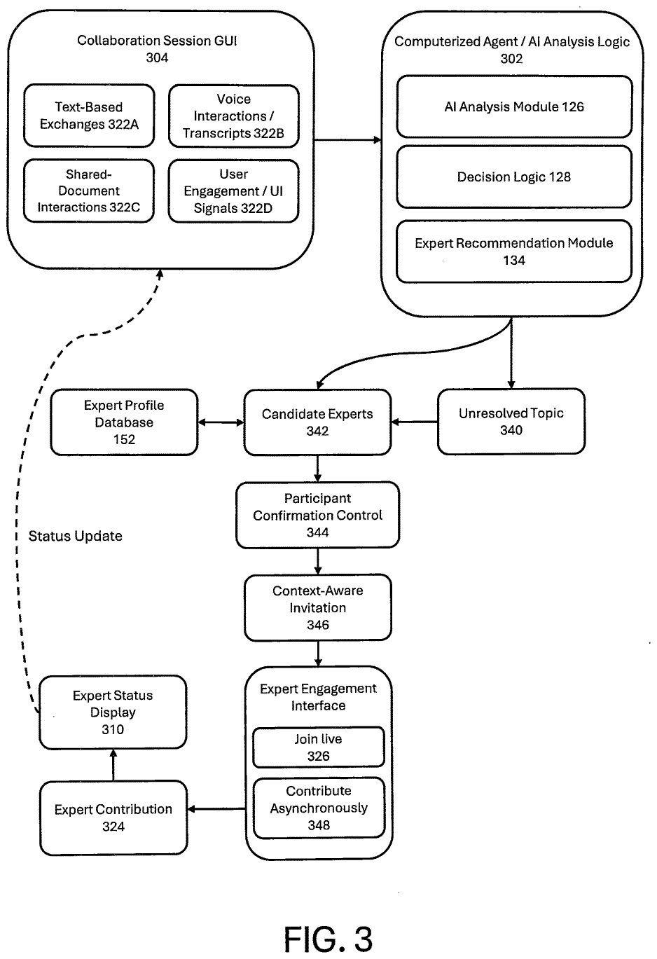

FIG. 3 illustrates an example AI-driven expert engagement workflow in which collaboration data 322 is obtained from a collaboration session graphical user interface 304 and processed by a computerized agent 302. The collaboration data 322 may include text-based exchanges 322A, voice interactions or transcript data 322B, shared-document interactions 322C, and user engagement or user-interface signals 322D. The computerized agent 302 may use an AI analysis module 126 to detect an unresolved topic 340 requiring expert input without requiring a participant-entered expert query. Decision logic 128 and an expert recommendation module 134 may query the expert profile database 152 to identify and rank candidate experts 342 based on expertise relevance, availability, prior contribution history, organizational relationship, project team relationship, professional network relationship, or authorized expert group membership. After identifying the candidate experts 342, the system may present a participant confirmation control 344 or expert-engagement control within the collaboration session graphical user interface 304. The participant confirmation control 344 may display one or more identified candidate experts 342 for participant confirmation before a context-aware invitation 346 is transmitted.

The context-aware invitation 346 may enable a selected expert to join live 326 or contribute asynchronously 348 through an expert engagement interface, and an expert contribution 324 or expert status display 310 may be displayed within the collaboration session graphical user interface 304.

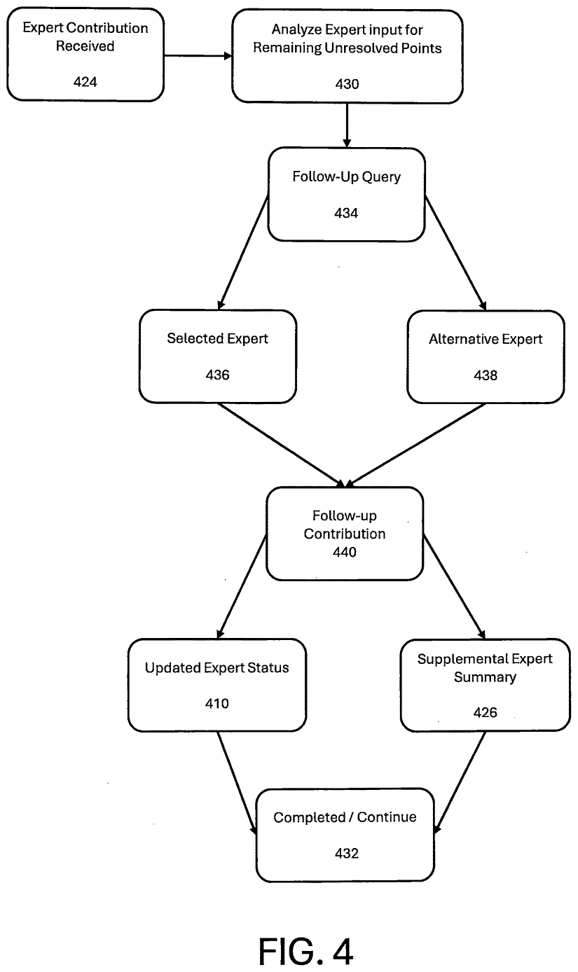

FIG. 4 illustrates an example follow-up workflow in which system 102 analyzes expert input, an expert contribution 424, or a structured expert summary to determine whether one or more unresolved discussion points remain. When additional expert engagement is required, system 102 may generate a follow-up query 434 and transmit the follow-up query 434 to a selected expert 436, to one or more participants, or to an alternative expert 438 identified from the expert profile database 152. Follow-up responses may be received through a live collaboration interface, asynchronous response interface, document review interface, chat channel, email notification, or mobile alert. System 102 may compile a follow-up contribution 440 into a supplemental expert summary 426, update an expert status display 410, and display the supplemental expert summary 426 or updated expert status display 410 in the graphical user interface. The workflow may then be completed or continued at 432 based on whether additional unresolved discussion points remain.

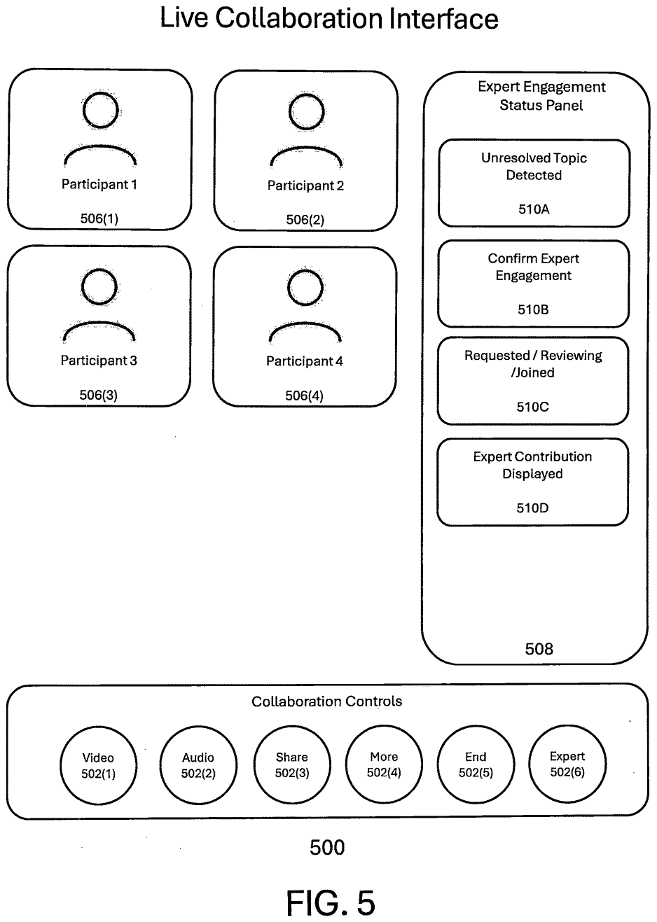

FIG. 5 illustrates an example graphical user interface 500 for a live collaboration session. The graphical user interface 500 may include participant regions 506(1)-506(4), collaboration controls 502(1)-502(6), and an expert engagement status panel 508. The collaboration controls 502(1)-502(6) may include video, audio, sharing, additional, end-session, and expert-engagement controls. The expert engagement status panel 508 may display a detected unresolved topic 510A, an expert confirmation control 510B, an expert-engagement status 510C, and an expert contribution display 510D. The expert-engagement status 510C may indicate whether a selected expert has been requested, is reviewing context, has joined the live collaboration session, has declined, is awaiting response, or has completed a contribution. The graphical user interface 500 may display a context-aware expert request generated from live collaboration data and may allow participants to confirm a selected expert, cancel an invitation, request an asynchronous response, or request follow-up clarification. When the selected expert accepts the invitation, the graphical user interface 500 may display the selected expert within the live collaboration session or provide access to a session-linked contribution interface through which expert input is presented to participants.

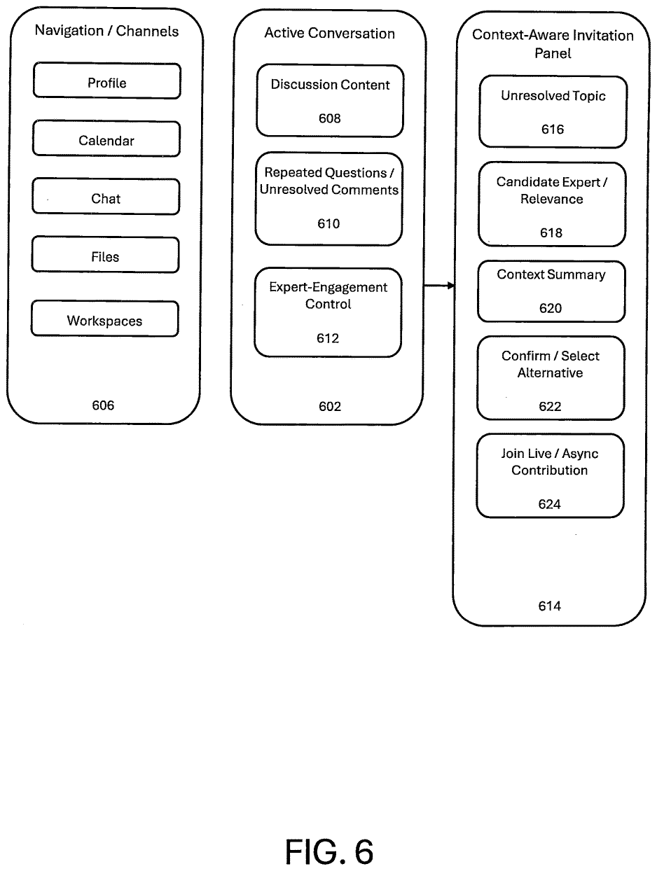

FIG. 6 illustrates an example expert-engagement control within a collaboration platform graphical user interface. The graphical user interface may include a navigation or channel region 606, an active conversation region 602, and a context-aware invitation panel 614. The active conversation region 602 may include discussion content 608, repeated questions or unresolved comments 610, and an expert-engagement control 612. The context-aware invitation panel 614 may display an unresolved topic 616, candidate expert information and relevance information 618, and a context summary 620 derived from collaboration data. The context summary 620 may include a topic summary, transcript excerpt, shared-document reference, task state, prior messages, or other session-linked context. The context-aware invitation panel 614 may include selectable controls 622 for confirming a selected expert or selecting an alternative expert, and selectable controls 624 for inviting an expert to join live or requesting an asynchronous contribution. The context-aware invitation may include a selectable link or control for joining the live collaboration session or contributing through a collaboration interface associated with the session. FIG. 6 further illustrates a collaboration-platform control workflow in which an AI recommendation is presented for participant confirmation before an expert invitation is transmitted.

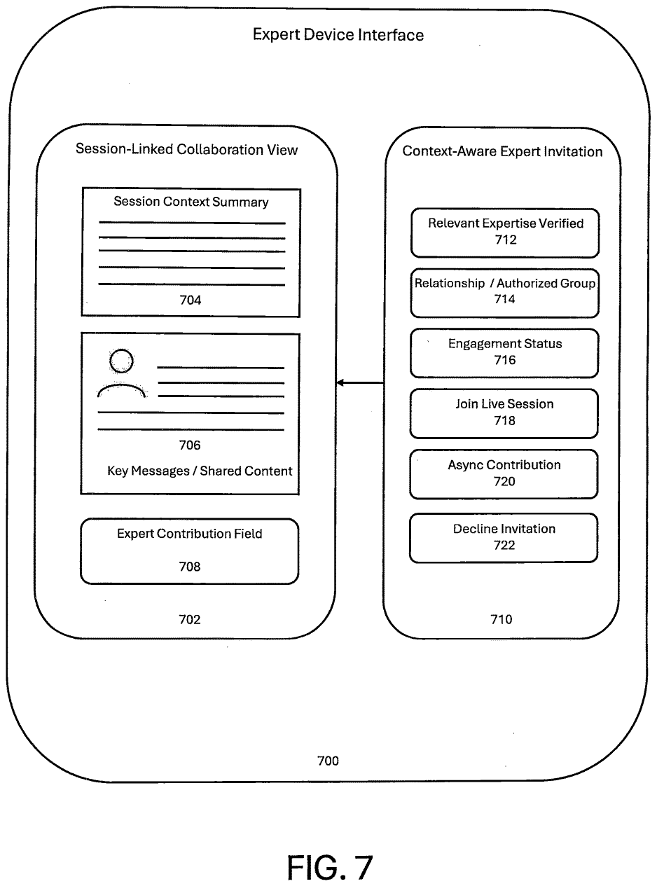

FIG. 7 illustrates an example expert device interface 700 for receiving and responding to a context-aware expert invitation associated with a collaboration session. The expert device interface 700 may include a session-linked collaboration view 702 and a context-aware expert invitation panel 710. The session-linked collaboration view 702 may display a session context summary 704, key messages or shared content 706, and an expert contribution field 708. The context-aware expert invitation panel 710 may display relevant expertise verification 712, relationship or authorized group information 714, engagement status 716, a join-live-session control 718, an asynchronous contribution control 720, and a decline-invitation control 722. The expert device interface 700 may enable the selected expert to review context derived from the collaboration session, join the live collaboration session, provide an asynchronous contribution, decline the invitation, or submit expert input through the expert contribution field 708. Status information and expert input received through the expert device interface 700 may be returned to system 102 for display within the collaboration platform and preservation with the session record.

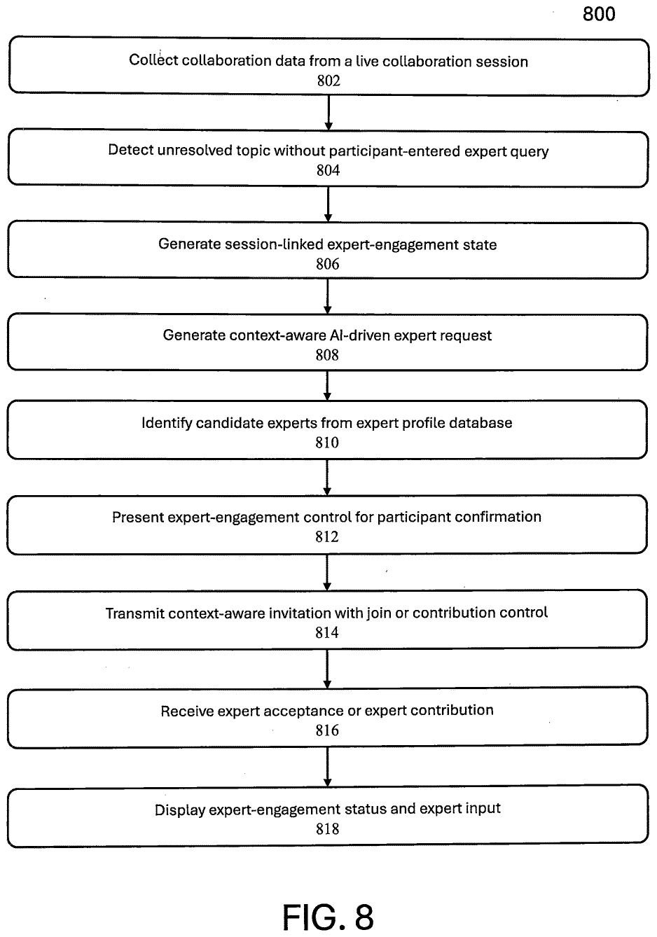

FIG. 8 illustrates an example method 800 for AI-driven expert engagement in a live collaboration session. At operation 802, collaboration data is collected from the live collaboration session. At operation 804, an AI analysis module determines, based on the collaboration data, that the live collaboration session includes an unresolved topic requiring expert input without requiring a participant-entered expert query. At operation 806, the system generates a session-linked expert-engagement state associated with the live collaboration session. At operation 808, the system generates a context-aware AI-driven expert request including context information derived from the collaboration data. At operation 810, the system identifies one or more candidate experts based on an expert profile database, such as expert profile database 152. At operation 812, the system presents an expert-engagement control in a collaboration-platform graphical user interface for participant confirmation. At operation 814, the system transmits a context-aware invitation to a selected expert, including context information and a selectable link or control for joining the live collaboration session or contributing through a collaboration interface associated with the live collaboration session. At operation 816, the system receives an expert acceptance or expert contribution. At operation 818, the system displays an expert-engagement status and expert input in the collaboration-platform graphical user interface.

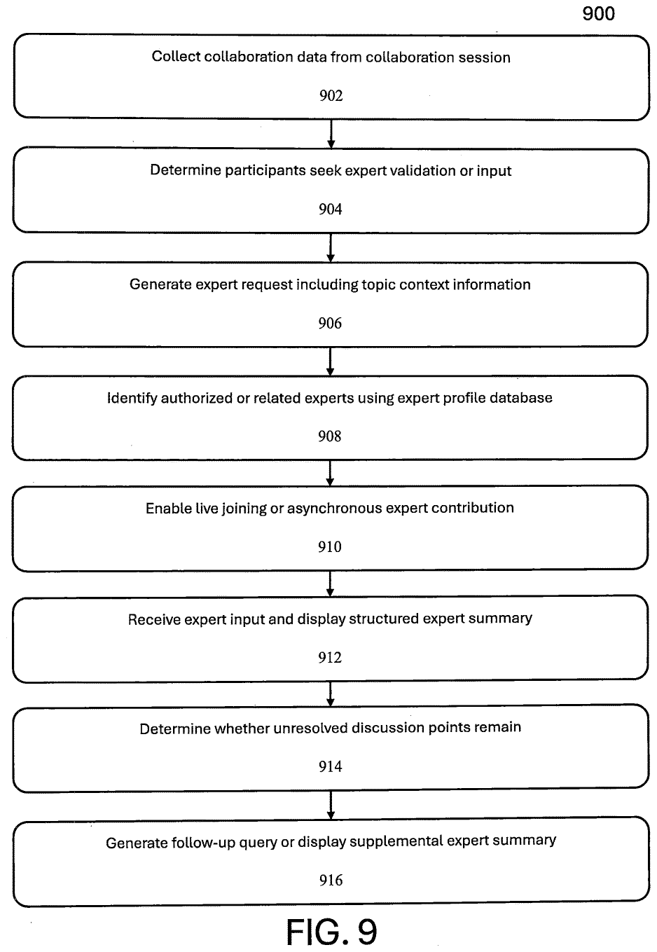

FIG. 9 illustrates an example system and asynchronous expert engagement workflow 900. At operation 902, system 102 collects collaboration data associated with a collaboration session. At operation 904, system 102 determines that participants seek expert validation or expert input regarding a discussed topic. At operation 906, system 102 generates an AI-driven expert request including context information associated with the discussed topic. At operation 908, system 102 identifies one or more authorized or related experts using an expert profile database, based at least in part on expert profile data and a relationship between at least one identified expert and at least one participant, organization, project team, professional network, or authorized expert group. At operation 910, system 102 enables live joining or asynchronous expert contribution through a collaboration interface associated with the collaboration session. At operation 912, system 102 receives expert input and displays the expert input or a structured expert summary. At operation 914, system 102 determines whether one or more unresolved discussion points remain. At operation 916, system 102 generates a follow-up query or displays a supplemental expert summary based on follow-up responses.

1. A computer-implemented method for enhancing a live collaboration session conducted through a collaboration platform, the method comprising: collecting, by one or more data processing devices connected to the live collaboration session via a data transmission network, collaboration data shared between participants during the live collaboration session; determining, by an artificial-intelligence analysis module and based on the collaboration data, that the live collaboration session includes an unresolved topic requiring expert input without requiring a participant-entered expert query; generating. based on the unresolved topic, a session-linked expert-engagement state for the live collaboration session, the session-linked expert-engagement state identifying the unresolved topic, context information derived from the collaboration data, and a status of an expert-engagement request; generating, based on the session-linked expert-engagement state, an AI-driven expert request including the context information derived from the collaboration data; identifying one or more experts, external to the participants, with relevant expertise based on an expert profile database; presenting, via a graphical user interface integrated with the collaboration platform, an expert-engagement control configured to display at least one of the identified experts and receive participant confirmation of a selected expert; transmitting, in response to the participant confirmation, a context-aware invitation to a data processing device associated with the selected expert, the context-aware invitation including the context information and a selectable link or control for joining the live collaboration session or contributing through a collaboration interface associated with the live collaboration session; receiving, via the data transmission network, an acceptance or expert contribution from the data processing device associated with the selected expert; updating, in response to receiving the acceptance or expert contribution, the session-linked expert-engagement state and displaying, via the graphical user interface integrated with the collaboration platform, an expert-engagement status associated with the selected expert; and displaying, via the graphical user interface, expert input received from the selected expert in association with the unresolved topic within the live collaboration session.

2. The computer-implemented method according to claim 1, wherein determining that the live collaboration session includes the unresolved topic comprises analyzing collected collaboration data including voice interactions, text-based exchanges, user engagement signals, shared-document interactions, audio-derived transcript content, or user-interface interaction data.

3. The computer-implemented method according to claim 1, wherein identifying the one or more experts comprises querying a dynamically updated expert profile database that ranks individuals based on subject matter expertise, prior contributions, availability, relevance to the unresolved topic, or prior responsiveness to session-linked expert-engagement requests.

4. The computer-implemented method according to claim 1, further comprising displaying the context-aware invitation in a graphical user interface on the data processing device associated with the selected expert, wherein the context-aware invitation includes multiple user-selectable response options comprising accepting the invitation, declining the invitation, joining the live collaboration session, or providing an asynchronous contribution.

5. The computer-implemented method according to claim 1, further comprising: analyzing the expert input to determine whether additional expert engagement is required; generating a follow-up query for one or more unresolved discussion points; updating the session-linked expert-engagement state to indicate a follow-up status; transmitting the follow-up query to the selected expert or to an alternative expert identified from the expert profile database; receiving a follow-up expert contribution; and displaying a supplemental expert summary in the graphical user interface in association with the live collaboration session.

6. The computer-implemented method according to claim 1, wherein determining that the live collaboration session includes the unresolved topic comprises recognizing the unresolved topic by analyzing speech-to-text transcripts, text-based discussions, shared content, or unresolved comments associated with the live collaboration session.

7. The computer-implemented method according to claim 1, wherein generating the AI-driven expert request comprises deriving the request from repeated or similar questions, unresolved comments, discussion patterns, or shared-content references detected in the collaboration data.

8. A computer-implemented method for managing expert engagement associated with a collaboration session, the method comprising: collecting, by one or more data processing devices connected to the collaboration session via a data transmission network, collaboration data shared between participants during the collaboration session; determining, based on the collaboration data, that the collaboration session includes a discussed topic for which expert validation or expert input is sought; generating a session-linked expert-engagement state identifying the discussed topic, context information associated with the discussed topic, and an expert-engagement status; generating an AI-driven expert request based on the session-linked expert-engagement state; identifying one or more experts, external to the participants, based on an expert profile database and a relationship between at least one identified expert and at least one participant, organization, project team, or professional network associated with the collaboration session; transmitting a context-aware invitation to at least one selected expert, the context-aware invitation enabling the selected expert to join the collaboration session or provide an asynchronous contribution through a collaboration interface associated with the collaboration session; receiving, via the data transmission network, expert input from the selected expert; updating the session-linked expert-engagement state based on the expert input; and displaying the expert input or a structured expert summary via a graphical user interface integrated with the collaboration platform in association with the collaboration session.

9. The computer-implemented method according to claim 8, further comprising: analyzing the expert input or structured expert summary to determine whether one or more unresolved discussion points remain; generating a follow-up query for further expert input; updating the session-linked expert-engagement state to indicate a follow-up status; transmitting the follow-up query to the selected expert, the participants, or an alternative expert; and displaying a supplemental expert summary based on follow-up responses.

10. The computer-implemented method according to claim 8, wherein determining that the collaboration session includes the discussed topic comprises analyzing collected collaboration data including voice interactions, text-based exchanges, explicit engagement indicators, shared-document interactions, or user-interface interaction data.

11. The computer-implemented method according to claim 8, wherein the collaboration session is conducted through a communication channel providing a graphical user interface for text-based chat, voice communication, video conferencing, asynchronous review, or shared-document review.

12. The computer-implemented method according to claim 8, wherein identifying the one or more experts comprises verifying that the identified experts and at least one participant belong to a same organization, project team, professional network, or authorized expert group.

13. The computer-implemented method according to claim 8, further comprising displaying the context-aware invitation in a graphical user interface, wherein the context-aware invitation includes multiple user-selectable response options comprising accepting the invitation, declining the invitation, joining the collaboration session, or providing an asynchronous response.

14. A system, comprising: one or more data processing devices; and a non-transitory computer-readable medium storing computer-executable instructions that, when executed by the one or more data processing devices, cause the one or more data processing devices to: collect collaboration data from participants in a live collaboration session via a data transmission network; determine, by an artificial-intelligence analysis module and based on the collaboration data, that the live collaboration session includes an unresolved topic requiring expert input without requiring a participant-entered expert query; generate, based on the unresolved topic, a session-linked expert-engagement state for the live collaboration session, the session-linked expert-engagement state identifying the unresolved topic, context information derived from the collaboration data, and a status of an expert-engagement request; generate, based on the session-linked expert-engagement state, an AI-driven expert request including the context information derived from the collaboration data; identify one or more experts, external to the participants, with relevant expertise based on an expert profile database; present, via a graphical user interface integrated with a collaboration platform, an expert-engagement control configured to display at least one of the identified experts and receive participant confirmation of a selected expert; transmit, in response to the participant confirmation, a context-aware invitation to a data processing device associated with the selected expert, the context-aware invitation including the context information and a selectable link or control for joining the live collaboration session or contributing through a collaboration interface associated with the live collaboration session; receive, via the data transmission network, an acceptance or expert contribution from the data processing device associated with the selected expert; update, in response to receiving the acceptance or expert contribution, the session-linked expert-engagement state and display, via the graphical user interface integrated with the collaboration platform, an expert-engagement status associated with the selected expert; and display, via the graphical user interface, expert input received from the selected expert in association with the unresolved topic within the live collaboration session.

15. The system according to claim 14, wherein the instructions further cause the one or more data processing devices to: analyze the expert input to determine whether one or more unresolved discussion points remain; generate a follow-up query for further expert input; update the session-linked expert-engagement state to indicate a follow-up status; transmit the follow-up query to the selected expert or to an alternative expert identified from the expert profile database; receive a follow-up expert contribution; and display a supplemental expert summary in the graphical user interface in association with the live collaboration session.

16. The system according to claim 14, wherein determining that the live collaboration session includes the unresolved topic comprises analyzing collected collaboration data including voice interactions, text-based exchanges, explicit engagement indicators, user engagement signals, shared-document interactions, audio-derived transcript content, or user-interface interaction data.

17. The system according to claim 14, wherein the collaboration interface enables real-time or asynchronous expert communication via text, voice, video, shared-document review, or session-linked annotation.

18. The system according to claim 14, wherein identifying the one or more experts comprises verifying that the identified experts and at least one participant belong to a same organization, project team, professional network, or authorized expert group.

19. The system according to claim 14, wherein the graphical user interface is configured to display the context-aware invitation or expert-engagement status, the expert-engagement status comprising requested, reviewing, joined, declined, awaiting response, follow-up requested, or completed.

20. (canceled)

21. (canceled)

22. (canceled)

23. (canceled)

24. (canceled)
